(19) United States
(12) Patent Application Publication
(10) Pub. No.: US 2004/0070895 A1
(43) Pub. Date: Apr. 15, 2004

(54) Leakage current detection interrupter extension cord with cord diagnostics and/or inadvertent ground-to-neutral detection

(76) Inventors: Bernard J. Gershen, Centerport, NY (US); Steve Campolo, Malverne, NY (US); James Richter, Bayside, NY (US); Lester Rivera, Glendale, NY (US); David Herzfeld, Huntington, NY (US); Roger M. Bradley, North Bellmore, NY (US)

Correspondence Address: GREENBERG TRAURIG, LLP, 885 Third Avenue, New York, NY, 10022, US

(21) Appl. No.: 10/267,424

(22) Filed: Oct. 9, 2002

(51) Int. Cl. H02H 3/00

(52) U.S. Cl. 361/42

(57) ABSTRACT

With prior art Immersion Detection Circuit Interrupters (IDCI), the firing of the trip coil to open the contacts which interrupts the flow of current to a load uses the neutral conductor as the return path when leakage is detected. If, however, the neutral conductor should become open, there is no return path present to fire the coil. An unsafe condition because the voltage that is present cannot be disconnected from the load. With this invention the SCR, which is used to fire the coil, now uses the ground conductor and diodes as the return path to fire the coil to interrupt the voltage from the load. A fully shielded cord is used to detect a break in a conductor. An LED indicator in either the plug or the receptacle of the extension cord verifies that protection is available. A test button is provided to test shield continuity and to verify proper circuit operation.

### BACKGROUND OF THE INVENTION

1. Field of the Invention

The invention is directed generally to electrical extension cords and power supply cords and, more specifically, to electrical extension and power supply cords having built in safety protection and diagnostics.

2. Description of the Prior Art

The electrical extension cord in use today includes a plug, usually comprising two or three prongs, an electrical conducting cord typically comprising two or three insulated wires several feet in length and a terminal connector or receptacle for receiving one or more electrical plugs to power lamps, a television, household appliances, an air conditioner, etc. A grounded extension cord includes a plug having three prongs and a three conductor insulated wire cord where two conductors are utilized for phase and neutral or return power and the third conductor is used as a common ground. While extension cords provide many advantages, there are some disadvantages that are also associated with their use. For example, extension cords are often left underneath rugs where they are trampled upon, or they are pinched by doors and furniture which can lead to arcing or short circuiting which can cause a fire. Extension cords also frequently tend to be left coiled where heat can concentrate, or are overloaded to the point of destruction by fire. Given the number of dangerous situations which can develop pursuant to extension cord use and abuse, such as residential fires and electrical shock, an extension cord design which offers some protection in anticipation of homeowner/user abuse is desired.

U.S. Pat. No. 5,642,248 assigned to Leviton Manufacturing Co., Inc. discloses an electrical extension cord where the insulated phase, neutral and ground conductors are surrounded by a braded sensing shield. The braded shield is electrically connected at the receptacle to the ground conductor and extends to the plug. Leakage current released from the conductors may be collected in the shield and detected by a Ground Fault Circuit Interrupter (GFCI). The purpose of the shield is to capture any type of leakage current or ground fault current within the extension cord such that the GFCI may detect the current imbalance.

A GFCI is capable of sensing and responding to the inadvertent grounding of the neutral conductor of an AC circuit having phase and neutral conductors. It is noted, however, that in certain applications the utilization of a GFCI is not practical. More specifically, the GFCI is a relatively expensive and complex device which requires the use of several transformers. In addition, the GFCI is often hardwired in a wall outlet or receptacle and is neither portable nor readily disconnected. Thus, unless each outlet in which an electrical device such as, for example, an appliance is to be utilized is protected by a GFCI, the user of the appliance, such as an air conditioner, is subject to possible injury if a shock hazard condition should exist in conjunction with a non-protected outlet. In addition, with certain conditions, the utilization of a conventional GFCI will not afford any shock hazard protection to the user if the neutral conductor of a cord should become open. This is so because, with a standard GFCI or Immersion Detection Circuit Interrupter (IDCI) circuit, normal tripping by firing of the trip coil to open the contacts in the phase and neutral conductors utilizes the neutral conductor as the return path when leakage is detected.

While a GFCI and an IDCI may offer some support in efforts to prevent problems associated with electrical extension cords, they do not address problems associated with trampled, pinched, ruptured or overloaded electrical extension cords.

It is now a requirement that window air conditioners be protected with a Leak Current Detection Interrupter (LCDI). Therefore, what is needed is an extension cord that contains diagnostics which can indicate if the extension cord is safe to connect a window air conditioner to a wall outlet. What is also needed is an extension cord having a plug which contains circuitry which interrupts the flow of current through the cord if an unsafe condition should arise.

### SUMMARY OF THE INVENTION

With prior art Immersion Detection Circuit Interrupters (IDCI), the firing of the trip coil to open the contacts which interrupts the flow of current to a load uses the neutral conductor as the return path when leakage is detected. If, however, the neutral conductor should become open, there is no return path present to fire the coil. An unsafe condition because the voltage that is present cannot be disconnected from the load. With this invention the SCR, which is used to fire the coil, now uses the ground conductor and diodes as the return path to fire the coil to interrupt the voltage from the load. A fully shielded cord is used to detect a break in a conductor. An LED indicator in either the plug or the receptacle of the extension cord verifies that protection is available. A test button is provided to test shield continuity and to verify proper circuit operation.

Other objects and features of the invention will be pointed out in the following description and claims and illustrated in the accompanying drawings, which disclose, by way of example, the principles of the invention, and the best mode, which is presently contemplated for carrying them out.

### BRIEF DESCRIPTION OF THE DRAWING

In the drawings in which similar elements are given similar reference characters:

FIG. 1 is a circuit diagram of a prior art LCDI circuit with reset lockout located in a plug;

FIG. 2 is a schematic of an LCDI circuit located in the plug of an extension cord and having a shield integrity indicator in the receptacle of the extension cord in accordance with the principles of the invention;

FIG. 3 is a schematic of an LCDI circuit located in the plug of an extension cord and having a shield integrity indicator in the plug of the extension cord in accordance with the principles of the invention;

FIG. 4 is a schematic of an LCDI circuit located in the plug of an extension cord and having a shield integrity indicator in the plug and a return wire in the cord in accordance with the principles of the invention;

FIG. 5 is a schematic of an LCDI circuit located in the plug of an extension cord and having a shield integrity test switch in the receptacle of the extension cord in accordance with the principles of the invention;

FIG. 6 is a schematic of an LCDI circuit located in the plug of an extension cord and having a shield integrity test switch in the plug in accordance with the principles of the invention;

FIG. 7 is a schematic of an LCDI circuit located in a plug of an extension cord and having an integrity indicator for shield and phase wire continuity in accordance with the principles of the invention;

FIG. 8 is a schematic of an LCDI circuit located in a plug of an extension cord and having an integrity indicator for shield and ground wire continuity in accordance with the principles of the invention and,

FIG. 9 is a schematic of an LCDI circuit located in the plug of an extension cord which trips when there is a short between the neutral and/or ground conductors and the shield conductor in accordance with the principles of the invention.

### DETAILED DESCRIPTION OF THE PREFERRED EMBODIMENT

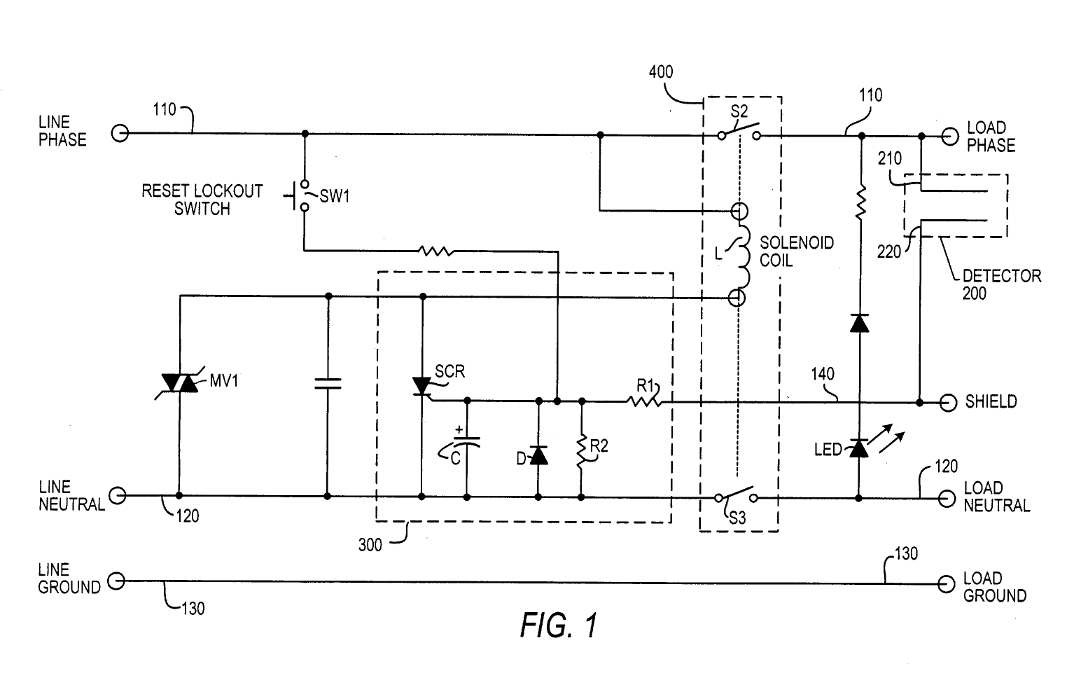

Referring to FIG. 1, there is illustrated a schematic diagram of a prior art Immersion Detection Circuit Interrupter (IDCI) circuit which provides shock hazard protection for water related shock hazard conditions within small electrical appliances connected to an AC source of 110-120 volts such as, for example, a hand held hair dryer as disclosed in U.S. Pat. No. 6,016,244 assigned to Leviton Manufacturing Co., Inc., and which is incorporated herein by reference in its entirety. In FIG. 1, electrical conductors 110, 120 are respectively connected to an AC source. A pair of hazard or immersion detection conductors 210, 220 are positioned in a non-contacting relationship within the device that is to be protected such as the hair dryer. The conductors are preferably located in proximity to a port of the appliance to be protected where water can enter.

One end of immersion detection conductor 210 is operatively connected to the phase conductor of an AC source via electrical conductor 110, and one end of the second immersion detection conductors 220 is connected to the shield conductor 130. The other ends of the immersion detection conductors 210, 220 are unconnected and maintained in a spaced apart relationship. Immersion of conductors 210, 220 in water creates a conductive path between the two conductors. Control circuit 300 comprises a solid state switching control circuit and includes a first resistor R1 connected in-line between the gate of a Silicon Controlled Rectifier (SCR) and the source end of the ground conductor 130. Resistor R1 limits the current applied to the gate of the SCR. The control circuit 300 includes a parallel network comprising resistor R2, capacitor C and diode D connected between the gate and cathode terminals of the SCR. These components provide a measure of noise immunity and protection against damage across the gate to cathode junction of the SCR.

Interrupter circuit 400 comprises an electrical circuit for interrupting the flow of current and includes an energizing coil L, a first switch S2 connected in-line with conductor 110 and a second switch S3 in-line with conductor 120. Switch S2 is responsive to the flow of current through energizing coil L and is closed when such current is not flowing. In response to the flow of such current, S2 switches from the normally closed position to the shock hazard condition open position. One end of energizing coil L is connected to first electrical conductor 110 and the other end thereof is connected to the anode terminal of the SCR. The cathode terminal of the SCR is operatively connected to electrical conductor 120.

The immersion of both unconnected ends of the pair of immersion detection conductors 210, 220 causes the electrical AC source to be operatively connected to the gate of the SCR via the path provided by electrical conductor 110, immersion detection conductor 210, the electrically conducting path provided by the water in which the unconnected ends of the immersion detection conductors 210, 220 are immersed, immersion detection conductor 220, electrical conductor 140, and resistor R1. In response thereto, the SCR switches from the normally non-conducting state to the shock hazard condition conducting state, thereby providing a path for current to flow through energizing coil L causing switch S2 to switch from the normally closed position to the shock hazard condition open position and thus operatively disconnect the AC source from the electrical appliance.

Electrical conductors 110, 120 and 130 comprise a three wire conductor having an AC source compatible plug at the source end, the control circuit 300 and interrupter circuit 400 contained in the plug, and the detector 200 contained within the appliance. Exemplary values for the circuit illustrated in FIG. 1 are as follows: R1 is 2000 ohms, R2 is 1000 ohms, C is 0.1microfarads, D is IN4004 and the SCR is 2N5064.

The electrical conductor 140 of FIG. 1 can be a single un-insulated wire which runs substantially parallel with the other wires in the cord, or it can be a spiral wound wire or a conductive shield which surrounds the insulated phase, neutral and ground conductors in the cord. In each embodiment of the invention here disclosed and illustrated in the FIGS. subsequent to FIG. 1, the electrical conductor 140 is referred to as being a conductive shield which surrounds the various conductors of the cord. It is to be understood that the term conductive shield as used here after comprises either a shield which surrounds the various conductors in the extension cord, or one or more wires in substantially parallel relationship with the other wires in the cord, or one or more wires which surround the various wires in the extension cord or the equivalent.

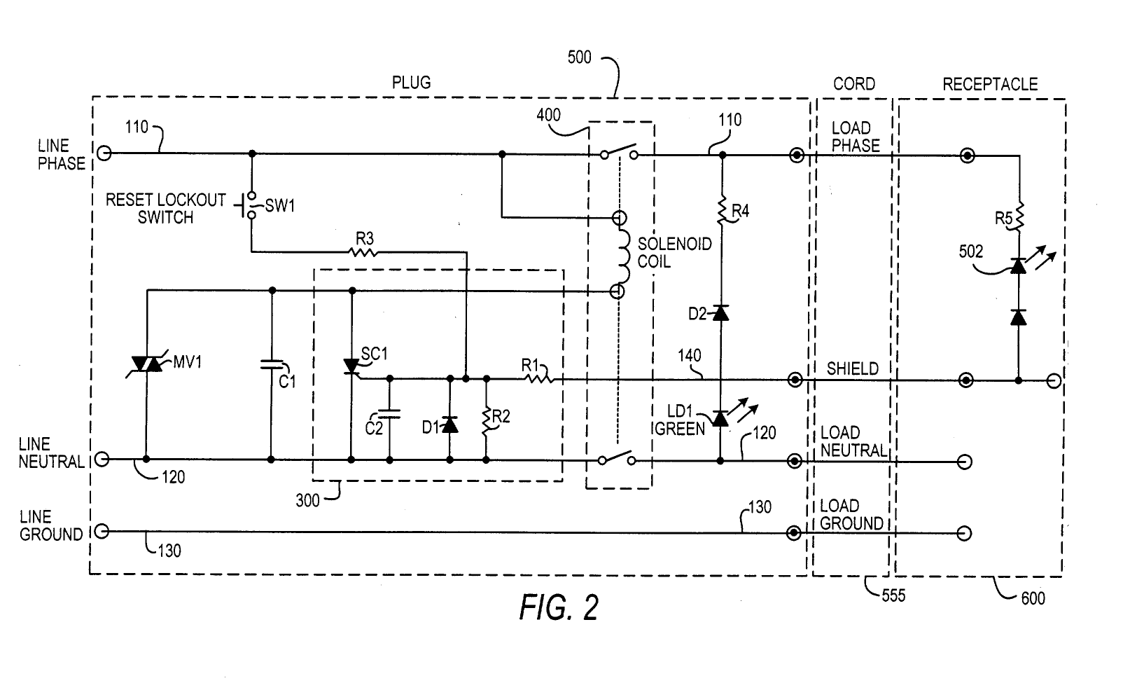

Referring to FIG. 2, there is illustrated a schematic of an LCDI circuit located within a plug of an extension cord and having a shield integrity indicator in the extension cord receptacle. The circuit located within the plug is similar to the circuit of FIG. 1 without the sense wires 210, 220 of the detector 200, and including an extension cord 555 completely enclosed within a shield 140 connecting plug 500 to receptacle 600. Thus, located within the shield 140 are the phase conductor 11, the neutral conductor 120 and the ground conductor 130. The occurrence of a break in any one of the conductors within the shield will be detected by the shield which, through the action of control circuit 300 and interrupter circuit 400 of the LCDI circuit in the plug 500 will operate to interrupt the flow of current through the plug to the extension cord 555. An LED 502 which may emit a green light is located within the receptacle to verify that protection is available. A test button can be provided to test the continuity of the shield and to verify proper circuit operation. To insure that the circuit is operating properly, a test circuit (not shown) comprising, for example, a resistor in series with a normally open switch connected between the load phase conductor 110 and the shield 140 can be utilized. Closing the normally open switch will cause the resistor to be connected across the phase conductor and shield and, if the circuit is operating as described above, the AC source will be operatively disconnected from the extension cord. Preferably, the test circuit is contained within the plug, In conjunction with the test circuit, there is provided a green light emitting diode 502. If the LED is illuminated when the test switch in the closed position, than the circuit is not operating properly.

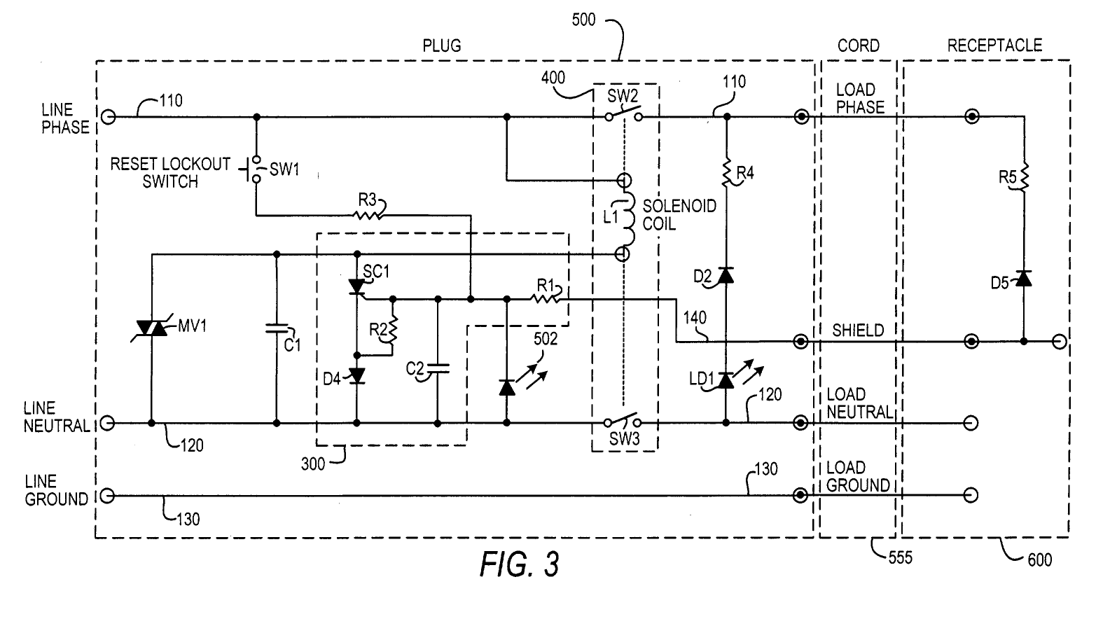

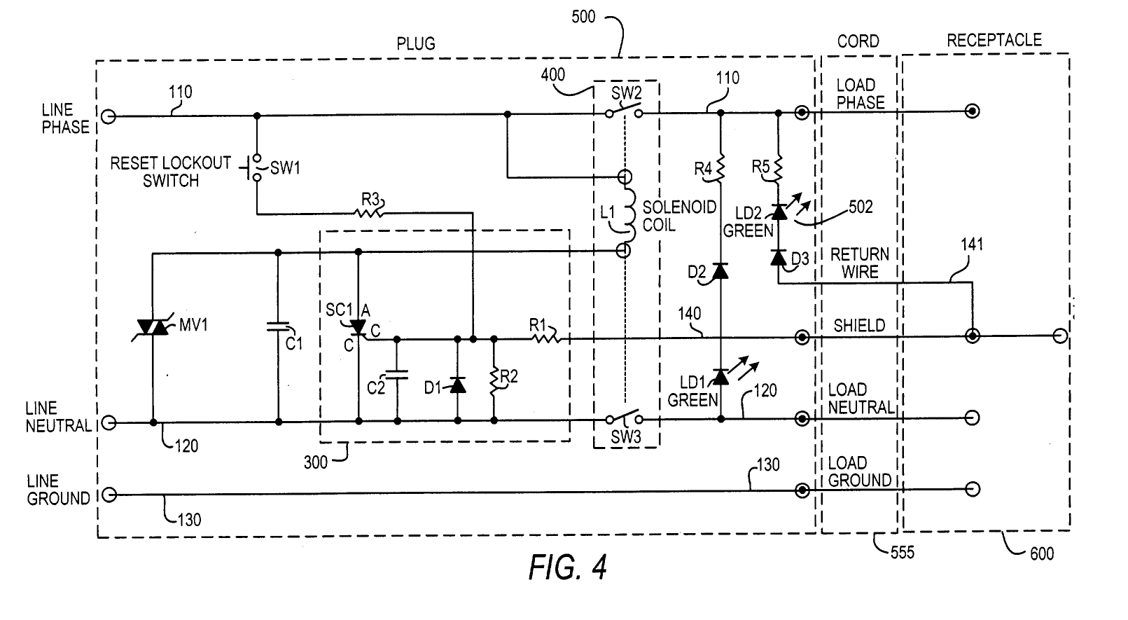

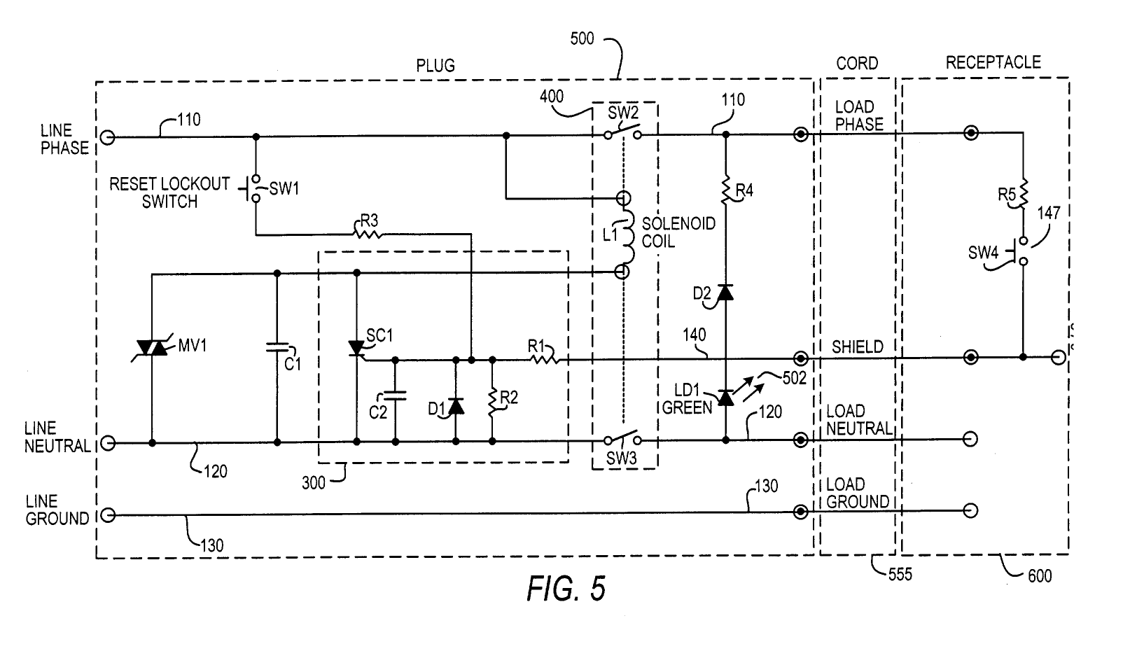

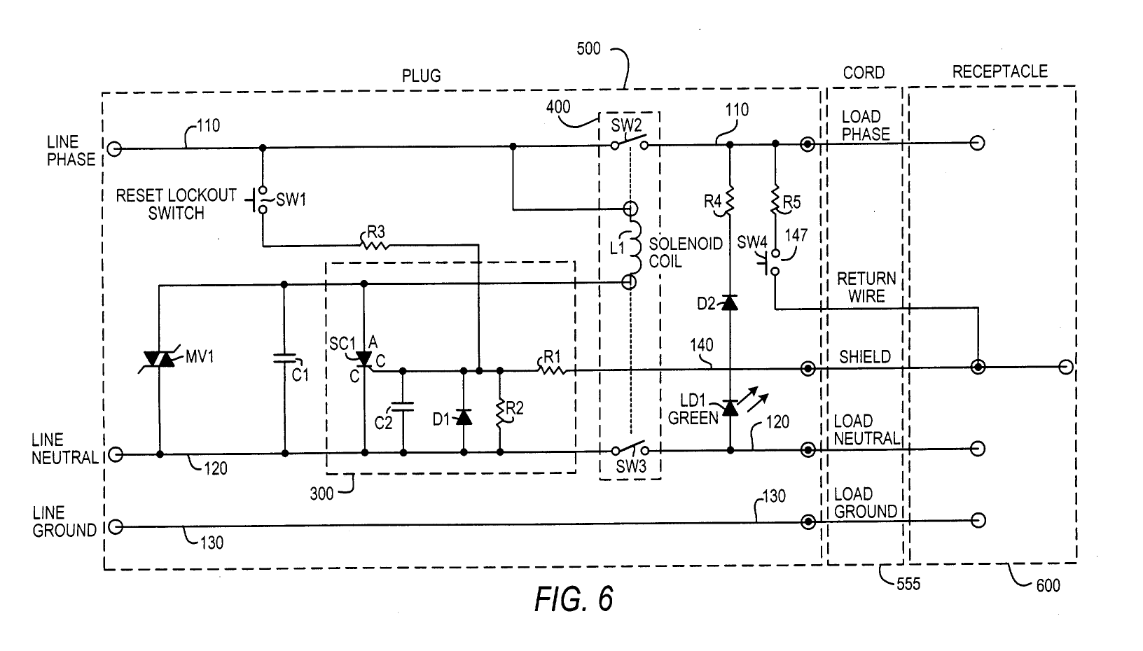

A leak circuit detection interrupter circuit located in the plug of an extension cord having a shield integrity indicator in the plug is illustrated in FIG. 3. The operation of the LCDI circuit of FIG. 3 is similar to that of FIG. 2 and, therefore, is not here repeated. A leak circuit detection interrupter circuit located in the plug of an extension cord and having a shield integrity indicator in the plug and a return wire 141 in the shield is illustrated in FIG. 4. The operation of the LCDI circuit of FIG. 4 is similar to that of FIG. 2 and, therefore, is not here repeated. A leak circuit detection interrupter circuit located in the plug of an extension cord having a shield integrity indicator test switch 147 in the extension cord receptacle is illustrated in FIG. 5. The operation of the LCDI circuit of FIG. 5 is similar to that of FIG. 2 and, therefore, is not here repeated. A leak circuit detection interrupter circuit located in the plug of an extension cord having a shield integrity indicator test switch 147 in the extension cord plug is illustrated in FIG. 6. The operation of the LCDI circuit of FIG. 6 is similar to that of FIG. 2 and, therefore, is not here repeated.

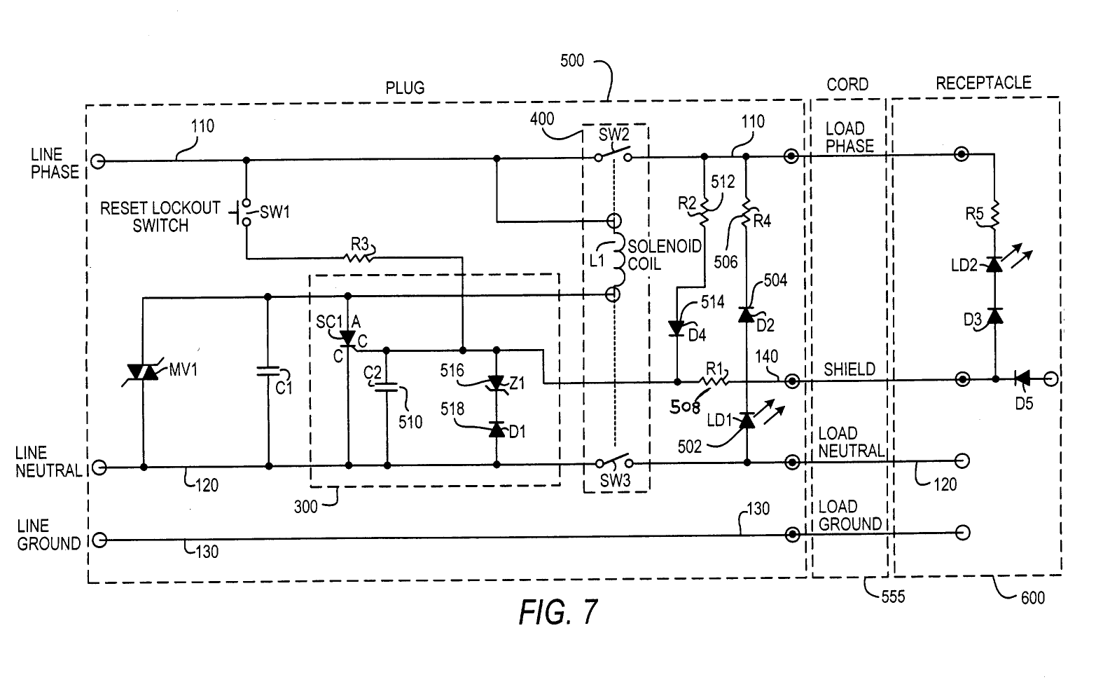

A leak circuit detection interrupter circuit located in the plug of an extension cord having shield and phase conductor integrity indicator is illustrated in FIG. 7. The operation of the circuit illustrated in FIG. 7 is described in U.S. Pat. No. 6,016,244 which is incorporated in this application by reference in its entirety. In FIG. 7, it is assumed that the shield 140 is intact and that it is energized. During the negative half cycle of the AC signal on phase conductor 110, a negative charging path via diode 504, resistor 506, shield 140 and resistor 508 provides a charge to capacitor 510, thereby charging it negatively. During the positive half cycle, diode 504 blocks, however a positive charging path via resistor 512 and diode 514 provides a charge to capacitor 510 thereby charging it positively. The time constant of resistor 506 and capacitor 510 is roughly 33 times greater than the time constant of resistor 512 and capacitor 510 and, therefore, the capacitor 510 charges much faster in the negative sense. Therefore, under steady state conditions a negative voltage exists on the gate of the SCR to keep it in a non-conductive state. In order to limit the negative voltage to a value that will not damage the gate-to-cathode junction of the SCR, a three volt zener diode 516 is added in series with diode 518 and in parallel with capacitor 510.

It is now assumed that the shield 140 is broken. Under this condition a negative charging path no longer exists for the negative voltage to be impressed of capacitor 510 and, therefore, during positive half cycles capacitor 510 will discharge. Eventually the voltage on the gate of the SCR will get high enough to trip the SCR, causing it to switch to the conducting state thereby operatively disconnecting the AC source from the extension cord.

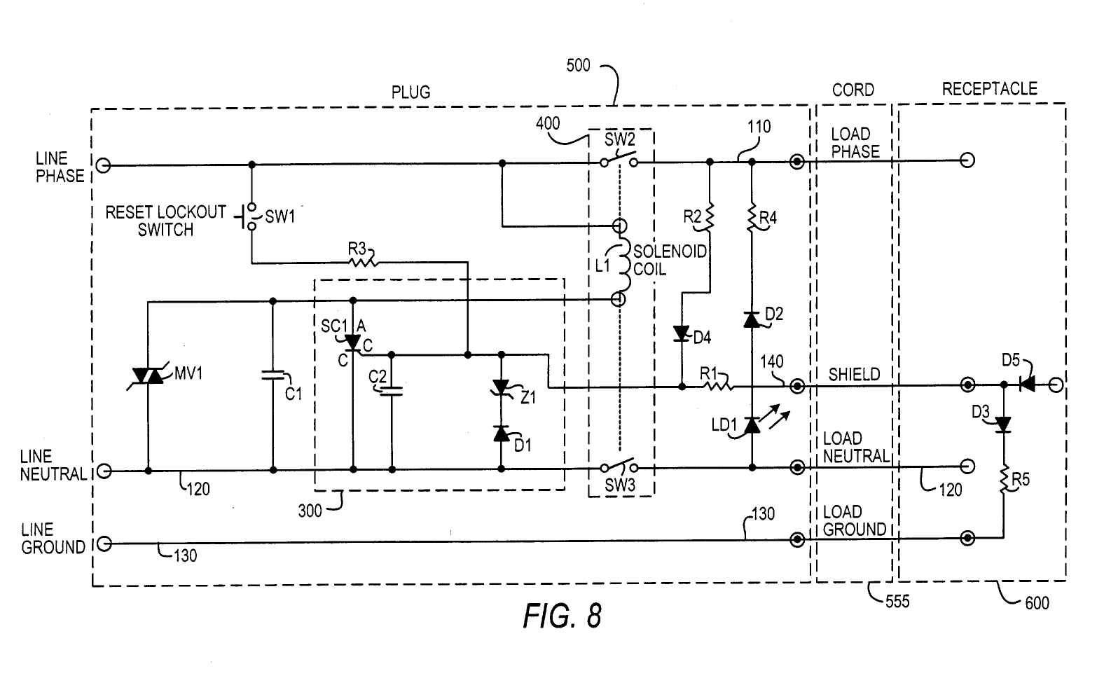

Referring to FIG. 8, there is shown the circuit of FIG. 7 modified to provide a leak circuit detection interrupter circuit located in the plug of an extension cord with an integrity indicator for shield and ground wire continuity. The operation of the circuit of FIG. 8 is similar to that of FIG. 7 and, therefore, is not here repeated.

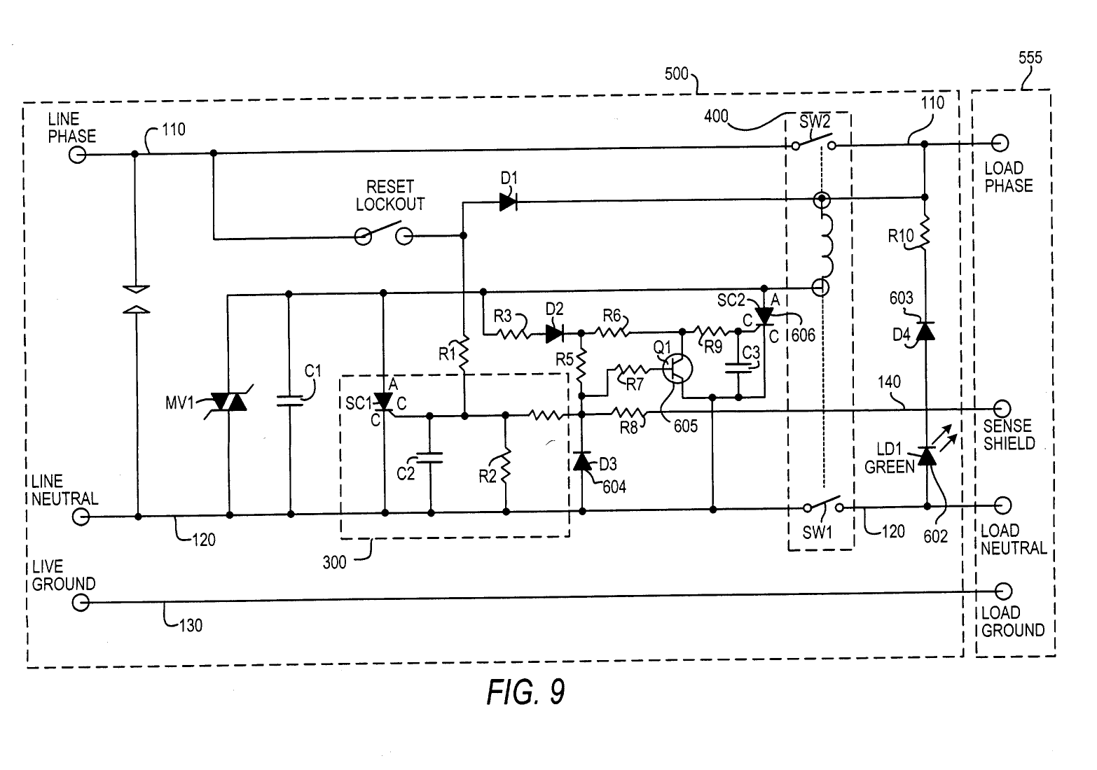

Referring to FIG. 9, there is shown an LCDI circuit located in the plug of an extension cord with trip occurring when there is a short between neutral, and/or ground conductors and the shield conductor. In this embodiment, the shield detects breaks in the conductors and, upon detecting a break, the circuit 400 in the plug interrupts the flow of current to the extension cord as an unsafe condition has occurred. An LED indicator 602 which can be located in the plug provides verification that protection is available. In addition, a test button ( not shown) is provided to test the continuity of the shield and to verify that the circuit is operating properly. With the prior art IDCI circuit, normal tripping (the firing of the trip coil to open the phase and line contacts) utilizes the neutral conductor as the return path when leakage is detected. This does not change. But, when the neutral conductor is broken and becomes open, there is no return path to fire the coil to disconnect the AC source from the extension cord. The circuit of FIG. 9 provides protection for this condition. In FIG. 9, the increased gate voltage will cause the SCR to conduct using the ground conductor as the return path through the two added diodes 603 and 604. The circuit will trip immediately if the neutral conductor is broken anywhere between the service entrance panel and the plug of the LCDI. The basic principle of operation of the circuit relies on the shield being biased to a predetermined voltage. When a short to neutral occurs with the shield, the voltage drops below a predetermined threshold voltage. The transistor 605 is then cut-off and the SCR 606 gate is allowed to trigger, thus latching the SCR to its on state. This allows enough current to flow in the coil and trip the relay in the interrupter circuit 400 to disconnect the source of current from the load.

In each embodiment here disclosed, the inclusion of an immersion detector, such as the detector 200 of the circuit shown in FIG. 1, in the receptacle will provide the extension cord with immersion protection.

While there have been shown and described and pointed out the fundamental novel features of the invention as applied to the various embodiments, as is presently contemplated for carrying them out, it will be understood that various omissions and substitutions and changes of the form and details of the device illustrated and in its operation may be made by those skilled in the art, without departing from the spirit of the invention.

What is claimed is:

1. An electrical extension cord comprising:
an electrical cable including separate, insulated phase, neutral and ground conductors surrounded by a conductive sensing shield wherein said cable is electrically connected at first ends of the phase, neutral, ground conductors and conductive sensing shield to a receptacle,
an electrical plug comprising a plug housing, phase, neutral and ground plug blades, and a fault circuit interrupter wherein the fault circuit interrupter is electrically connected at load end phase, neutral and shield ports to the cable at second ends of the phase, neutral and shield conductors, and at line end phase and neutral ports to the phase and neutral plug blades and wherein the ground conductor is electrically connected to the ground plug blade, such that leakage current is collected by the shield enabling protection of the extension cord by the fault circuit interrupter.

2. The electrical extension cord of claim 1, wherein the extension cord contains an integrity indicator which denotes if the extension cord is safe to use.

3. The electrical extension cord of claim 1, wherein the fault circuit interrupter in the plug electrically isolates the receptacle of the extension cord from the plug if an unsafe condition should arise.

4. The electrical extension cord of claim 2, wherein the integrity indicator is located in the receptacle of the extension cord.

5. The electrical extension cord of claim 3, wherein the integrity indicator is a light.

6. The electrical extension cord of claim 3, further comprising a switch located in the receptacle for testing the integrity of the extension cord.

7. The electrical extension cord of claim 6, wherein the switch in the receptacle is used to test for shield continuity.

8. The electrical extension cord of claim 6, wherein the switch in the receptacle tests the fault circuit interrupter by simulating a leakage condition in the extension cord.

9. The electrical extension cord of claim 1, further comprising a sensor located in the receptacle coupled to activate the fault circuit interrupter to electrically disconnect the receptacle from the plug upon exposure of the sensor to a conducting medium.

10. The electrical extension cord of claim 1, wherein the fault circuit interrupter electrically disconnects the receptacle from the plug should the shield become discontinuous.

11. The electrical extension cord of claim 1, wherein the fault circuit interrupter is a leakage current detection interrupter.

12. The electrical extension cord of claim 2, wherein the integrity indicator is located in the plug of the extension cord.

13. The electrical extension cord of claim 12, further comprising a return conductor located within the extension cord connecting the end of the shield conductor located in the receptacle to the integrity indicator in the plug.

14. The electrical extension cord of claim 12, wherein the integrity indicator is a light.

15. The electrical extension cord of claim 14, further comprising a switch located in the receptacle for testing the integrity of the extension cord.

16. The electrical extension cord of claim 15, wherein the switch in the plug is used to test for shield continuity.

17. The electrical extension cord of claim 15, wherein the switch in the plug tests the fault circuit interrupter by simulating a leakage condition in the extension cord.

18. The electrical extension cord of claim 1, further comprising coupling at least one diode between the phase conductor or the neutral conductor to bias the shield to a predetermined voltage.

19. The electrical extension cord of claim 18, further comprising coupling a first diode between the neutral conductor and the shield and a second diode between the phase conductor and the shield.

20. The electrical extension cord of claim 19, wherein the first and second diodes are located in the plug.
